(19) United States
(12) Patent Application Publication
(10) Pub. No.: US 2002/0154246 A1
(43) Pub. Date: Oct. 24, 2002

(54) Method and apparatus for control of auxiliary video information display

(76) Inventor: Bret David Hawkins, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/116,401

(22) Filed: Apr. 4, 2002

Related U.S. Application Data
(60) Provisional application No. 60/284,852, filed on Apr. 19, 2001.

(51) Int. Cl. H04N 11/00

(52) U.S. Cl. 348/465; 348/738

(57) ABSTRACT

A video signal receiver is operative to control display of video information. Particularly, a video signal receiver is operative to provide controlled display of video information pertaining to a television program signal in response to a parameter of the television program signal. More particularly, a television signal receiver is operative to provide controlled display of auxiliary video information of a television program signal in response to a parameter of an audio signal portion of the television program signal. In one form, a television signal receiver is operative to control display of video program information with regard to a television program signal in response to a parameter level of a parameter of an audio program portion of the television program signal. The television signal receiver includes reference level setter, a signal comparator, and a video signal modifier. The reference level setter is operative to set a reference level. The signal comparator is operative to compare a signal level of an audio program portion of a television signal to the reference level. The video signal modifier is operative to modify a video signal representing a video program portion of the television signal in response to the audio program portion comparison.

This non-provisional U.S. patent application claims priority to and/or the benefit of provisional U.S. patent application Serial. No. 60/284,852 filed Apr. 19, 2001, entitled Method and Apparatus For Control of Auxiliary Video Information Display.

### FIELD OF THE INVENTION

The present invention relates to television signal processing and, more particularly, to television signal processing systems that include provisions for processing auxiliary video information such as closed caption data.

### BACKGROUND OF THE INVENTION

A video signal processing section of a television system includes provisions for decoding and displaying auxiliary video information such as closed captioned data. Closed captioned data includes ASCII digital data representing text corresponding to audio information, such as speech, that may be included in a television signal. The closed captioned data is displayed on the screen of the television system when the closed caption feature is enabled and is intended to provide a visual representation of the spoken portion of a television program as an aid, for example, to hearing impaired television viewers. In the United States for example, a closed captioning standard is set forth by the Federal Communication Commission “FCC” Regulations (see e.g. 47 CFR §§ 15.119 and 73.682). FCC regulations specify that digital closed caption data is to be transmitted in line 21 of field 1 in the video signal. Data representative of two ASCII characters is transmitted in each occurrence of line 21 of field 1.

Closed captioning data is extracted from the video signal by a decoder. The decoder signal is coupled to the video display when the closed captioning function/feature is enabled by a viewer. Closed captioning is usually enabled by selecting the closed captioning function from a menu displayed on the video screen during a control mode of operation such as a set-up mode of operation. Once activated, closed captioning typically remains enabled until a viewer activates the appropriate menu and de-selects (disables) the closed captioning function/feature.

One drawback to the current implementation of closed captioning is that a viewer may hesitate to use closed captioning because enabling and disabling closed captioning can require time consuming navigation of set-up menus. Additionally, viewers who are not hearing impaired may never bother to enable closed captioning because the closed captioning display may interfere with the display of the video program. Thus, closed captioning is a feature included in most televisions but seldom used by most television viewers.

It is well known that when viewing a television program, a significant variation in audio signal levels may occur. For example, a character in a television program may be shouting in one instance and whispering in another. As well, one character may speak more loudly than another character. If a viewer adjusts the audio level to a setting appropriate for the loud audio portions of the television program, softly spoken speech may be inaudible unless the audio level is adjusted by the viewer. Frequent variations in audio level may necessitate corresponding frequent adjustment of the audio level that can quickly become annoying to a viewer.

### SUMMARY OF THE INVENTION

In accordance with one form of the subject invention, a signal processing system is operative to control display of video information. Particularly, a system for processing video and audio signals is operative to provide controlled display of video information pertaining to a television program signal in response to a parameter of the television program signal. More particularly, a television signal processing system is operative to provide controlled display of auxiliary video information of a television program signal in response to a parameter of an audio signal portion of the television program signal.

In accordance with one aspect of the invention, a method for controlling display of video information comprises the steps of monitoring an audio program portion of a television signal, and modifying a video signal representing a video program portion of the television signal in response to the monitoring of the audio program portion.

In accordance with another aspect of the subject invention, a method for controlling display of video information includes setting a reference level, comparing a signal level of an audio program portion of a television signal to the reference level, and modifying a video signal representing a video program portion of the television signal in response to the audio signal comparison.

In accordance with another form of the subject invention, a television signal processing apparatus is operative to control display of video information. The apparatus for processing the television signal includes means for monitoring an audio program portion of a television signal, and means for modifying a video signal representing a video program portion of the television signal in response to the monitoring of the audio program portion. Another aspect of the described apparatus relates to the monitoring means including means for setting a reference level and means for comparing a signal level of the audio program portion of the television signal to the reference level.

In accordance with another aspect of the subject invention, a television signal receiver is operative to control display of video program information with regard to a television program signal in response to a parameter level of a parameter of an audio program portion of the television program signal. The television signal receiver includes a reference level setter, a signal comparator, and a video signal modifier. The reference level setter is operative to set a reference level. The signal comparator is operative to compare a signal level of an audio program portion of a television signal to the reference level. The video signal modifier is operative to modify a video signal representing a video program portion of the television signal in response to the audio program portion comparison.

### BRIEF DESCRIPTION OF THE DRAWINGS

The above-mentioned and other features and advantages of this invention, and the manner of attaining them, will become more apparent and the invention will be better understood by reference to the following description of an exemplary embodiment of the invention taken in conjunction with the accompanying drawings, wherein:

FIG. 1 depicts, in block diagram form, an exemplary basic apparatus constructed in accordance with the principles of the subject invention;

FIG. 2 depicts, in block diagram form, an exemplary apparatus constructed in accordance with the principles of the subject invention;

FIG. 3 depicts, in flow chart form, an exemplary manner of operation in accordance with the principles of the subject invention; and

FIG. 4 depicts, in flow chart form, a second exemplary manner of operation in accordance with the principles of the subject invention.

Corresponding reference characters indicate corresponding parts throughout the several views.

### DETAILED DESCRIPTION

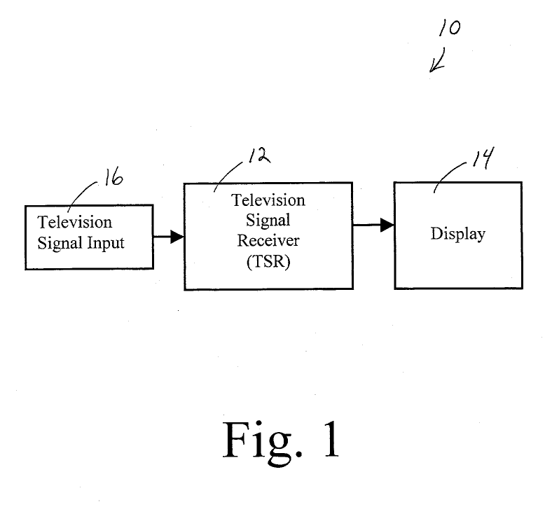

Referring now to FIG. 1, there is shown a system, generally designated 10, that is configured, operative, and/or adapted to process video and audio signals. Exemplary embodiments are described herein in the context of receiving and processing a television program signal that includes an auxiliary information signal portion or component, a video program signal portion or component, and an audio program signal portion or component. However, the invention is also applicable to systems involving apparatus and/or a method for receiving and processing separate signals associated with audio, video, and auxiliary information signal components. In addition, the television signal and/or the program signal components may be either analog or digital. The signal or signals, e.g., a television signal, may come from any source, as represented by the signal input 16 in FIG. 1. The video program portion typically includes auxiliary information or data that may or may not pertain to the program carried by the television program signal. However, a system constructed or operating in accordance with the invention may receive auxiliary information as a separate signal. In addition, the auxiliary information may include, but is not limited to, data pertaining to closed caption/captioning, teletext, program guide, and/or the like.

System 10 shown in FIG. 1 includes apparatus for processing a television signal, e.g., television signal receiver (TSR) 12, that is coupled to a display 14. The display 14 may or may not be integral with the TSR 12. As such, the television signal receiver 12, and television signal processing apparatus or system as used herein, may be any type of device that is operative to receive and process a television signal or television signals, either with or without a display device, such as, without being limiting, a television, a cable box, a satellite receiver, a general set-top box, a digital video interface, and/or the like. The display 14 may be any type of video display such as a cathode ray tube, LCD screen, plasma screen, and/or the like.

The television signal receiver 12 receives a television signal via a television signal input 16. The television signal input 16 is representative of a television signal and/or the input thereof. In accordance with an aspect of the subject invention, the television signal receiver 12 is operative to receive and process the television signal representing a television program (a television program signal) as well as monitor a parameter associated with the television program and set a level of a parameter of the television program signal for use in the monitoring operation. Particularly, the television signal receiver 12 is operative to allow the setting of a parameter level or value, the parameter level pertaining to an aspect or parameter of the audio program portion and/or video program portion of the television program signal. The television signal receiver 12 is further operative to process or monitor the television program signal and control the display of video program information from or with respect to the television program signal on the display 14 based on, or in response to, the monitoring operation involving, for example, comparing a selected parameter level and a parameter value of the audio program portion and/or the video program portion of the television program signal. Particularly, the television signal receiver 12 is operative to process the television program signal and control the display of auxiliary video program information pertaining to (and typically contained within) the television program signal according to a comparison of the selected parameter level of the audio program portion and a parameter value of the audio program portion of the television program signal. In the context of the exemplary embodiments described herein, the auxiliary video program signal, auxiliary program signal, or simply auxiliary information comprises closed caption/closed captioning information/data, the parameter value is audio level of the audio program portion of the television program signal, and the parameter level is an audio level.

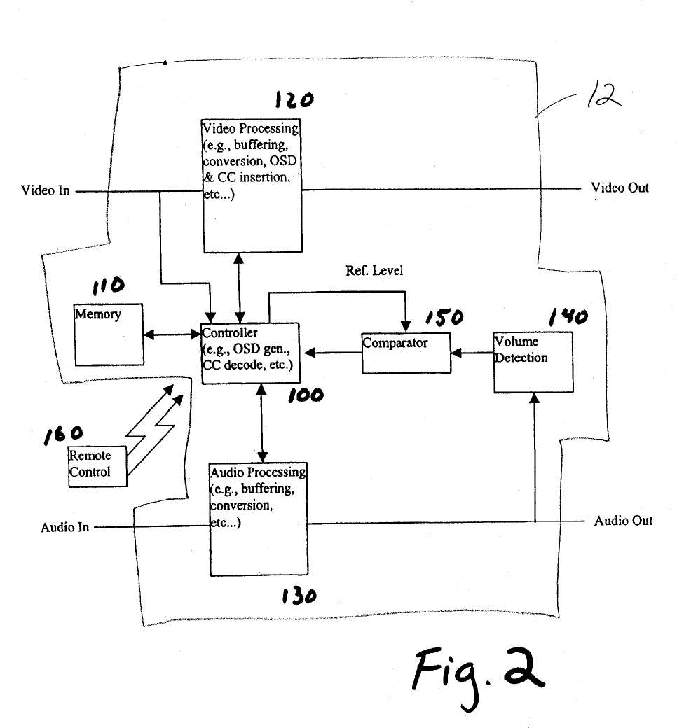

Referring now to FIG. 2 there is shown an embodiment of the television signal receiver 12. Particularly, the television signal receiver 12 is operated to process a television signal in accordance with the principles of the subject invention as described herein. The television signal receiver 12 includes a controller, control circuitry/logic, and/or the like 100, a memory, memory circuitry/logic, and/or the like 110, a video processor, processor/processing circuitry/logic, processing unit and/or the like 120, an audio processor, processor/processing circuitry/logic, processing unit, and/or the like 130, a volume detector, detector circuitry/logic, and/or the like 140, and a comparator, comparator circuitry/logic, and/or the like 150. A remote control, control unit, and/or the like 160 is shown that is operative to accept user input and transmit the user input to the television signal receiver 12. As such, the television signal receiver 12 is operative to receive, decode, and process the transmitted user input. User input via the remote control 160 is typically in response to a set-up menu or set-up menus or the like generated by the television signal receiver 12 and shown on the display 14. User input, however, may be accomplished by other means (e.g., via switches such as front-panel controls of the television receiver and/or via a remote device such as a PC or other control device connected to the television receiver via a home network).

The controller 100 controls the operation of the television signal receiver 12 and is coupled to the other components and or functions as shown in FIG. 1 as well as functions not shown in FIG. 1 that are part of a television signal receiver such as input signal sources including but not limited to a tuner and signal selection switches for selecting a source of input signals.

The input signals to the television signal receiver 12 comprise video input signals coupled to an input (Video In) of the video processing unit 120 and an audio input signal coupled to an input (Audio In) of the audio processing unit 130. User control of the television signal receiver 12 occurs by operating the remote control 160 for example to select signal sources (such as devices in our channels) and establish set up parameters of the television receiver 12. One such parameter in accordance with the subject invention is enabling and/or disabling of display of video program information comprising auxiliary information such as closed captioning and enabling or disabling of an auxiliary information control feature. Set up parameters may be established by user selection of parameters from on screen display “OSD” menus as well. A video signal representing the OSD menus is generated by the controller 100 and the video processing unit 120 in response to remote control signals from the remote control 160, output from the video processing unit 120 as part of the signal VIDEO OUT, and displayed on the display device 14 such as a kinescope or flat panel display.

The video input and audio input signals represent video and audio program portions or signal components, of a television signal or television program signal. As is well known, the video and audio input signals shown in FIG. 2 may represent signal components received directly as separate signal components from devices such as a VCR or may represent signal components that have decoded from a television signal such as an NTSC television signal. If the NTSC signal was received modulated at RF frequencies, e.g., broadcast or cable TV signals, the video and audio input signals are produced by video and audio IF units not shown in FIG. 2.

In addition to control the operation of the television signal receiver 12 in generating OSD information, the controller 100 receives the video input signal and when closed captioning is enabled, decodes closed captioned information included in the video signal. The decoded closed captioned information is formatted into a form suitable for display, e.g., using the OSD processor portion of the controller 100 and coupled to the video processor 120 for insertion into the video out signal when appropriate to produce the desired closed captioned display.

A volume detector 140 is coupled to receive the audio out signal for determining a signal level of the audio signal, and a comparator 150 coupled to receive both a reference level from the control 100 and a signal representing the audio signal level determined by the volume detector 140. The comparator 150 produces an output signal indicating the relationship between the audio signal level and the reference level, e.g., the audio signal level exceeds or is less than the reference level. The controller 100 responds to the relationship-indicating signal produced by the comparator 100 for modifying the video out signal produced by the video processor 120. An example of the operation of the television receiver 12 in accordance with the principles of the subject invention will now be described.

First, a user activates a set-up menu preferably using the remote control 160 and enables a feature that will be referred to herein as an “active closed captioning” feature that involves enabling decoding and display of auxiliary information such as closed captioning when the level of the audio out signal drops below a reference (or parameter or threshold) level or value. The reference level could be a set level, e.g. 5 dB, or as part of enabling the active closed captioning feature, a user could establish the reference level by, for example, using the remote control to set the volume to a level that produces the desired volume while in the set-up mode of operation. When the set-up mode is exited, the reference or parameter level (volume level) will be stored by the controller 100, e.g., in the memory 110 as the audio signal reference level.

After exiting the set-up mode with active closed captioning mode enabled and the reference level established, the volume detector 140 determines the signal level of the audio out signal of a television program signal. The audio out signal is compared to the reference level by the comparator 150. The resulting comparison produces a signal indicating the relationship of the audio signal level to the reference level and/or indicating whether the reference level is exceeded or not. The controller 100 monitors the relationship-indicating signal and enables and disables the display of closed captioning in response to the audio out signal level exhibiting a particular relationship to the reference level. For example, closed captioning is enabled in response to the audio out signal level being less than the reference level, and disabled in response to the audio out signal level rising above the reference level.

One approach to determining the audio out signal level in the volume detector 140 is to maintain a running average of the audio out signal level over a period of, for example, the previous few seconds. Alternatively, while the volume detector 140 and the comparator 150 are indicated as being separate devices, these functions may be implemented in software by the controller 100. Such a software implementation may be particularly advantageous if the audio processor 130 includes digital signal processing of the audio signal that can provide a digital representation of the audio out level, e.g., in decibels, that can be monitored by the controller 100 and compared to the reference level stored in the memory 110.

Processing of the comparison result to determine whether the audio out signal level exhibits a particular relationship to the reference level could also involve considering time periods. For example, closed captioning could be enabled in response to the audio out signal level being less than the reference level for a first period of time and then closed captioning could be disabled in response to the audio out signal exceeding the reference level for a second period of time. The first and second periods of time could be equal or unequal and could be set by a user using a set up menu feature as described above.

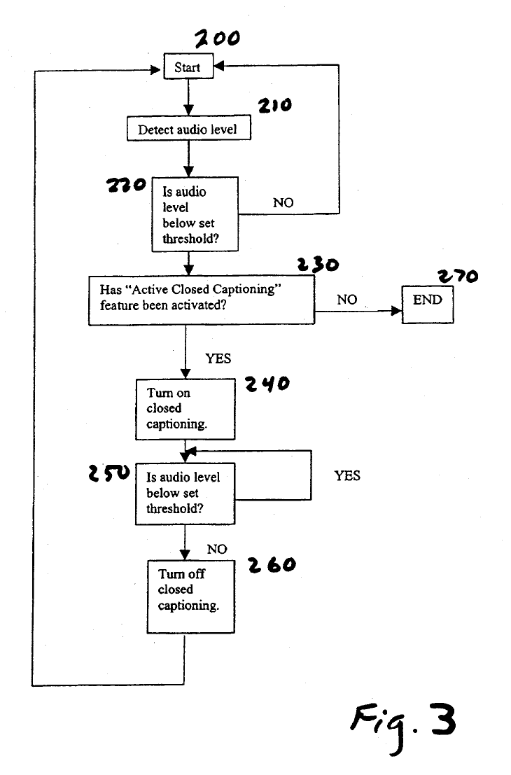

Referring now to FIG. 3, there is illustrated an exemplary method of operation for the system 10, particularly the television signal receiver 12, shown in FIGS. 1 and 2. In FIG. 3, execution of the routine e.g., by the controller 100, begins at step 200 and is followed by monitoring of the audio level of a television program signal at steps 210 and 220. Particularly, in step 210 the audio level is detected. In step, 220 it is determined whether the audio level (or value) of the audio program portion of the television program signal is below the set threshold (or audio or parameter level) or the exact relationship of the audio level (or value) of the audio program portion of the television program signal and the set or predetermined threshold audio level. If the audio value (or level) is not below a set threshold reference level, steps 210 and 220 are repeated to provide continuous monitoring of the audio level of the audio program portion of the television program signal. If the audio signal level is less then the reference level or threshold, the routine checks at step 230 to see if the active closed caption feature is enabled. If so, closed captioning is turned on at step 240 followed by the audio level being checked again in step 250. As long at the audio level remains below the reference level, step 250 is repeated and closed captioning remains enabled. When step 250 is executed and the audio signal level is above a reference level, closed captioning is turned off at step 260 followed by the routine staring again at step 200. When the active closed captioning feature is disabled, execution of step 230 will end the routine at step 270.

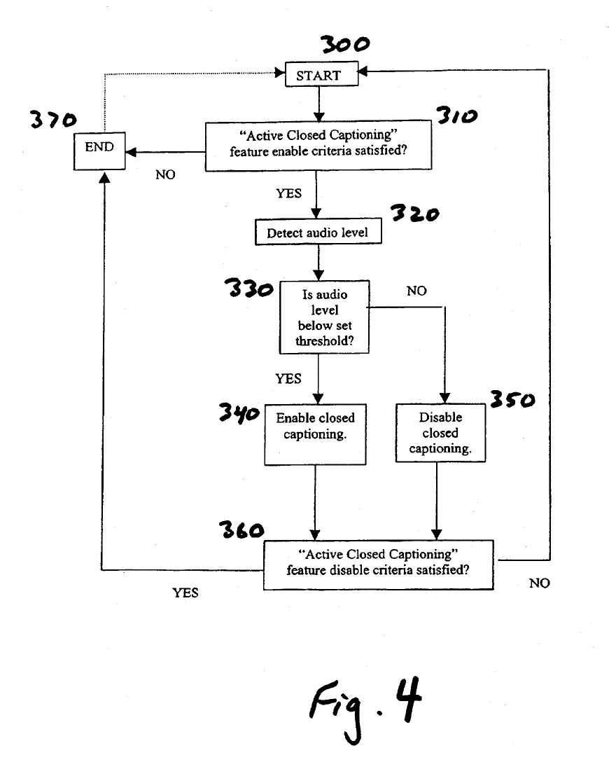

Another aspect of the subject invention is shown in the flow chart of FIG. 4. In addition to depicting a different arrangement of a closed captioning enabling and disabling flow in comparison to that as shown in FIG. 3, the exemplary method shown in FIG. 4 also includes steps in which enable criteria and disable criteria are tested to see if such criteria are satisfied. For example, these criteria can determine when and for how long the active closed captioning feature is or has been enabled. As a specific example, a disable criteria might be a particular time period such as thirty minutes or the length of the current program, i.e., the active closed captioning feature is enabled for a particular time period and/or program and is disabled when the program and/or time period ends.

In FIG. 4, after the routine is entered at 300, a test occurs at step 310 to determine whether the active closed captioning enable criteria are satisfied to determine whether the feature is enabled, e.g., has the enable date and time occurred? If so, the audio level is tested at step 320. If the audio level or value is less than the reference level, closed captioning is enabled at step 340. If the audio level is greater than the set threshold level, closed captioning is disabled at step 350. Following step 340 or step 350, the active closed captioning disable criteria are tested to determine whether to disable the feature. If the criteria are not satisfied, the feature remains enabled and the routine is repeated at step 300. If the disable criteria are satisfied, step 360 is followed by the end of the routine at step 370. The routine also ends at step 370 after step 310 if the enable criteria are not satisfied.

As other examples of enable and disable criteria for controlling and enabling the disabling of the active closed captioning with regard to FIG. 4, the enable/disable criteria could define a particular date and/or time period (e.g. enable the feature tonight at 6:00 pm and disable at 9:00 pm). Also, the criteria could be a particular program. That is, the user could enter the name of a particular program and the controller 100 could compare the program name to program guide information stored, for example, in an electric program guide “EPG” database to determine when the particular program is televised. The active closed captioning feature can then be enabled or disabled during a particular program. The active closed captioning feature could also be enabled for certain channels and disabled for certain channels. Enabling and disabling of the feature could be included as a parameter specifying a user profile such as that included in systems such as DirecTV direct broadcast satellite signal receivers manufactured by Thomson Consumer Electronics, Inc. of Indianapolis, Ind. Including the active closed captioning feature as an option in the user profile parameters would permit enabling the feature for certain users and disabling it for others.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

What is claimed is:

1. A method for controlling display of video information in television signal processing apparatus (12) comprising the steps of:
monitoring an audio program portion of a television signal; and
modifying a video signal representing a video program portion of the television signal in response to the monitoring of the audio program portion.

2. The method of claim 1, further comprising a step of:
setting a reference level prior to the step of monitoring the audio program portion; and wherein
the step of monitoring the audio program portion comprises the step of comparing a signal level of the audio program portion to the reference level.

3. The method of claim 2, wherein the step of setting the reference level comprises the step of setting the reference level via a set-up menu; and wherein the step of setting the reference level via a set-up menu includes the step of allowing user input via the set-up menu for setting the reference level.

4. The method of claim 2, wherein the step of comparing a signal level of an audio program portion of a television signal to the reference level includes the step of detecting a signal level of an audio program portion of a television signal.

5. The method of claim 2, wherein the step of modifying a video signal representing a video program portion of the television signal in response to the audio signal comparison includes the step of enabling display of auxiliary information pertaining to the television signal in response to the audio signal comparison indicating that the signal level of the audio portion of the television signal is less than the reference level.

6. The method of claim 5, wherein the step of enabling display of auxiliary information pertaining to the television signal in response to the audio signal comparison indicating that the signal level of the audio portion of the television signal is less than the reference level includes the step of enabling closed captioning of the auxiliary information.

7. Apparatus (12) for processing a television signal comprising:
means for monitoring an audio program portion of the television signal;
means (100) for modifying a video signal representing a video program portion of the television signal in response to the monitoring of the audio program portion.

8. The apparatus (12) of claim 7, wherein the means for monitoring comprises:
means (100) for setting a reference level; and
means (150) for comparing a signal level of an audio program portion of a television signal to the reference level.

9. The apparatus (12) of claim 8, wherein the means for setting the reference level comprises means for setting the reference level via a set-up menu (100), and includes means for allowing user input (160) via the set-up menu for setting the reference level.

10. The apparatus (12) of claim 8, wherein the means for comparing a signal level of an audio program portion of a television signal to the reference level (150) includes means for detecting a signal level of an audio program portion of a television signal (140).

11. The apparatus (12) of claim 8, wherein the means for modifying a video signal representing a video program portion of the television signal in response to the audio signal comparison (120) includes means for enabling display of auxiliary information pertaining to the television signal in response to the audio signal comparison indicating that the signal level of the audio portion of the television signal is less than the reference level (120).

12. The television signal receiver (12) of claim 11, wherein the means for enabling display of auxiliary information pertaining to the television signal in response to the audio signal comparison indicating that the signal level of the audio portion of the television signal is less than the reference level (120) includes means for enabling closed captioning (100, 120) of the auxiliary information.

13. A television signal receiver (12) comprising:
a reference level adjuster (100) operative to set a reference level;
a signal comparator (150) operative to compare a signal level of an audio program portion of a television signal to the reference level; and
a video signal modifier (120) operative to modify a video signal representing a video program portion of the television signal in response to the audio program portion comparison.

14. The television signal receiver (12) of claim 13, wherein the reference level adjuster (100) includes an OSD generator (100) operative to set the reference level via a set-up menu.

15. The television signal receiver (12) of claim 14, wherein the OSD generator (100) allows user input (160) via the set-up menu for setting the reference level.

16. The television signal receiver (12) of claim 15, wherein the signal comparator (150) includes a detector operative to detect a signal level of an audio program portion of a television signal (140).

17. The television signal receiver (12) of claim 13, wherein the video signal modifier (120) includes an auxiliary information processor operative to enable display of auxiliary information pertaining to the television signal in response to the audio signal comparison indicating that the signal level of the audio portion of the television signal is less than the reference level (120).

18. The television signal receiver (12) of claim 17, wherein the auxiliary information processor (100) includes a closed captioned processor (100, 120).
